(19) United States
(12) Patent Application Publication
(10) Pub. No.: US 2002/0062268 A1
(43) Pub. Date: May 23, 2002

(54) Scheme for presenting recommended items through network based on access log and user preference

(76) Inventors: Motoi Sato, Tokyo (JP); Takeshi Motohashi, Tokyo (JP)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/997,502

(22) Filed: Nov. 20, 2001

(30) Foreign Application Priority Data
Nov. 20, 2000 (JP) P2000-353110
Nov. 20, 2000 (JP) P2000-353111

(51) Int. Cl. G06F 17/60

(52) U.S. Cl. 705/27

(57) ABSTRACT

A recommended item presentation device uses the access log for viewing/purchasing items on the item provider server made by the client as the analysis source information, so that there is less burden of input on the client side and it becomes possible to collect a large amount of the analysis source information, and the rating input for each item or the list of preferred items as the user preference estimating factor information indicating the user preference, so that it becomes possible to explicitly indicate the user preference and to change it whenever necessary.

### BACKGROUND OF THE INVENTION

1. Field of the Invention

The present invention relates to a scheme for presenting recommended items to a client through a network.

2. Description of the Related Art

The conventional methods for presenting recommended items have been using the ratings of the items as “user preference estimating factor information” and “analysis source information”. For example, there has been a method in which the clients are requested to select and enter their ratings of books or the like in such terms as “very bad”, “bad”, “neutral”, “good”, and “very good”.

The above described conventional methods are methods in which the rating is entered as the “user preference estimating factor information” indicating the preference of the user, the ratings of the others are used as the “analysis source information”, a group of clients who made the similar ratings are picked up by a general correlation analysis or the like, and a list of items that are commonly rated highly by that group of clients. These methods have been associated with the problem that the entry of the rating requires some time and effort so that the amount of the analysis source information (the user preference estimating factor information) is rather small.

On the other hand, the method for presenting recommended items using the log of viewing/purchasing items as the “user preference estimating factor information” and “analysis source information” as disclosed in Japanese Patent Application No. 2000-209827 has an advantage that it requires no time and effort for the entry of the rating so that it is possible to collect a large amount of the “analysis source information”, but it has been associated with the problem that it is difficult to explicitly indicate the user preference in the “user preference estimating factor information”.

Also, in this conventional method disclosed in Japanese Patent Application No. 2000-209827, it is possible to present the recommended items by collecting the access logs of as many users as about one million users, but collecting the access logs of ten million users or one hundred million users has been difficult because of the excessively enormous numbers involved in view of the network load and the server processing power.

### SUMMARY OF THE INVENTION

It is therefore an object of the present invention to provide a scheme for presenting recommended items through a network which is capable of collecting a large amount of the “analysis source information” and explicitly indicating the user preference.

It is another object of the present invention to provide a scheme for presenting recommended items through a network which is capable of presenting the service with respect to an enormous number of clients while suppressing the requirements on the network load and the server processing power.

According to one aspect of the present invention there is provided a recommended item presentation method, comprising the steps of: (a) receiving access logs for viewing/purchasing items by clients from an item provider server which provides items to a plurality of clients through a network, converting the access logs into access log maps suitable for a recommended item presentation processing, and storing the access log maps; (b) receiving and storing item rating values indicating levels of preference of clients regarding specific items from the clients; (c) receiving a recommended item presentation request from a client; (d) producing a recommended item list for the client who issued the recommended item presentation request, according to the item rating values and the access log maps for the client who issued the recommended item presentation request; and (e) transmitting the recommended item list to the client who issued the recommended item presentation request.

According to another aspect of the present invention there is provided a recommended item presentation method, comprising the steps of: (a) receiving and storing access log collecting target client data indicating those clients who are targets for collecting access logs for viewing/purchasing items by clients from an item provider server which provides items to a plurality of clients through a network, and those clients who are not targets for collecting the access logs from the item provider server; (b) receiving the access logs for clients from the item provider server, extracting only the access logs of those clients who are targets for collecting the access logs from the access logs received from the item provider server according to the access log collecting target client data stored by the step (a), converting only extracted access logs into access log maps suitable for a recommended item presentation processing, and storing the access log maps; (c) receiving a recommended item presentation request from a client; (d) producing a recommended item list for the client who issued the recommended item presentation request, according to the access log maps for the client who issued the recommended item presentation request; and (e) transmitting the recommended item list to the client who issued the recommended item presentation request.

According to another aspect of the present invention there is provided a recommended item presentation method, comprising the steps of: (a) receiving access log collecting target client data indicating those clients who are targets for collecting access logs for viewing/purchasing items by clients from an item provider server which provides items to a plurality of clients through a network, and those clients who are not targets for collecting the access logs from the item provider server, sending access log transmission requests to those clients who are targets for collecting the access logs, and sending access log transmission stopping requests to those clients who are not targets for collecting the access logs; (b) receiving the access logs from those clients who are targets for collecting the access logs, converting the access logs into access log maps suitable for a recommended item presentation processing, and storing the access log maps; (c) receiving a recommended item presentation request from a client; (d) producing a recommended item list for the client who issued the recommended item presentation request, according to the access log maps for the client who issued the recommended item presentation request; and (e) transmitting the recommended item list to the client who issued the recommended item presentation request.

According to another aspect of the present invention there is provided a recommended item presentation device, comprising: a first unit configured to receive access logs for viewing/purchasing items by clients from an item provider server which provides items to a plurality of clients through a network, convert the access logs into access log maps suitable for a recommended item presentation processing, and store the access log maps; a second unit configured to receive and store item rating values indicating levels of preference of clients regarding specific items from the clients; a third unit configured to receive a recommended item presentation request from a client; a fourth unit configured to produce a recommended item list for the client who issued the recommended item presentation request, according to the item rating values and the access log maps for the client who issued the recommended item presentation request; and a fifth unit configured to transmit the recommended item list to the client who issued the recommended item presentation request.

According to another aspect of the present invention there is provided a recommended item presentation device, comprising: a first unit configured to receive and store access log collecting target client data indicating those clients who are targets for collecting access logs for viewing/purchasing items by clients from an item provider server which provides items to a plurality of clients through a network, and those clients who are not targets for collecting the access logs from the item provider server; a second unit configured to receive the access logs for clients from the item provider server, extracting only the access logs of those clients who are targets for collecting the access logs from the access logs received from the item provider server according to the access log collecting target client data stored by the first unit, convert only extracted access logs into access log maps suitable for a recommended item presentation processing, and store the access log maps; a third unit configured to receive a recommended item presentation request from a client; a fourth unit configured to produce a recommended item list for the client who issued the recommended item presentation request, according to the access log maps for the client who issued the recommended item presentation request; and a fifth unit configured to transmit the recommended item list to the client who issued the recommended item presentation request.

According to another aspect of the present invention there is provided a recommended item presentation device, comprising: a first unit configured to receive access log collecting target client data indicating those clients who are targets for collecting access logs for viewing/purchasing items by clients from an item provider server which provides items to a plurality of clients through a network, and those clients who are not targets for collecting the access logs from the item provider server, send access log transmission requests to those clients who are targets for collecting the access logs, and send access log transmission stopping requests to those clients who are not targets for collecting the access logs; a second unit configured to receive the access logs from those clients who are targets for collecting the access logs, convert the access logs into access log maps suitable for a recommended item presentation processing, and store the access log maps; a third unit configured to receive a recommended item presentation request from a client; a fourth unit configured to produce a recommended item list for the client who issued the recommended item presentation request, according to the access log maps for the client who issued the recommended item presentation request; and a fifth unit configured to transmit the recommended item list to the client who issued the recommended item presentation request.

According to another aspect of the present invention there is provided a computer usable medium having computer readable program codes embodied therein for causing a computer to function as a recommended item presentation device, the computer readable program codes include: a first computer readable program code for causing said computer to receive access logs for viewing/purchasing items by clients from an item provider server which provides items to a plurality of clients through a network, convert the access logs into access log maps suitable for a recommended item presentation processing, and store the access log maps; a second computer readable program code for causing said computer to receive and store item rating values indicating levels of preference of clients regarding specific items from the clients; a third computer readable program code for causing said computer to receive a recommended item presentation request from a client; a fourth computer readable program code for causing said computer to produce a recommended item list for the client who issued the recommended item presentation request, according to the item rating values and the access log maps for the client who issued the recommended item presentation request; and a fifth computer readable program code for causing said computer to transmit the recommended item list to the client who issued the recommended item presentation request.

According to another aspect of the present invention there is provided a computer usable medium having computer readable program codes embodied therein for causing a computer to function as a recommended item presentation device, the computer readable program codes include: a first computer readable program code for causing said computer to receive and store access log collecting target client data indicating those clients who are targets for collecting access logs for viewing/purchasing items by clients from an item provider server which provides items to a plurality of clients through a network, and those clients who are not targets for collecting the access logs from the item provider server; a second computer readable program code for causing said computer to receive the access logs for clients from the item provider server, extracting only the access logs of those clients who are targets for collecting the access logs from the access logs received from the item provider server according to the access log collecting target client data stored by the first computer readable program code, convert only extracted access logs into access log maps suitable for a recommended item presentation processing, and store the access log maps; a third computer readable program code for causing said computer to receive a recommended item presentation request from a client; a fourth computer readable program code for causing said computer to produce a recommended item list for the client who issued the recommended item presentation request, according to the access log maps for the client who issued the recommended item presentation request; and a fifth computer readable program code for causing said computer to transmit the recommended item list to the client who issued the recommended item presentation request.

According to another aspect of the present invention there is provided a computer usable medium having computer readable program codes embodied therein for causing a computer to function as a recommended item presentation device, the computer readable program codes include: a first computer readable program code for causing said computer to receive access log collecting target client data indicating those clients who are targets for collecting access logs for viewing/purchasing items by clients from an item provider server which provides items to a plurality of clients through a network, and those clients who are not targets for collecting the access logs from the item provider server, send access log transmission requests to those clients who are targets for collecting the access logs, and send access log transmission stopping requests to those clients who are not targets for collecting the access logs; a second computer readable program code for causing said computer to receive the access logs from those clients who are targets for collecting the access logs, convert the access logs into access log maps suitable for a recommended item presentation processing, and store the access log maps; a third computer readable program code for causing said computer to receive a recommended item presentation request from a client; a fourth computer readable program code for causing said computer to produce a recommended item list for the client who issued the recommended item presentation request, according to the access log maps for the client who issued the recommended item presentation request; and a fifth computer readable program code for causing said computer to transmit the recommended item list to the client who issued the recommended item presentation request.

Other features and advantages of the present invention will become apparent from the following description taken in conjunction with the accompanying drawings.

### BRIEF DESCRIPTION OF THE DRAWINGS

FIG. 1 is a block diagram showing an exemplary configuration of a recommended item presentation system according to the first embodiment of the present invention.

FIG. 2 is a flow chart for the processing at a time of producing an access log map in a recommended item presentation device shown in FIG. 1.

FIG. 3 is a diagram showing an exemplary form of a list of item identifiers and their distances for each client identifier that can be used in a recommended item presentation device shown in FIG. 1.

FIG. 4 is a diagram showing an exemplary form of a list of client identifiers and their distances for each item identifier that can be used in a recommended item presentation device shown in FIG. 1.

FIG. 5 is a flow chart for the processing at a time of recording item ratings in a recommended item presentation device shown in FIG. 1.

FIG. 6 is a diagram showing an exemplary form of item rating recording data that can be used in a recommended item presentation device shown in FIG. 1.

FIG. 7 is a flow chart for the processing at a time of a recommended item presentation request in a recommended item presentation device shown in FIG. 1.

FIG. 8 is a flow chart for the processing at a time of generating a recommended item list in a recommended item presentation device shown in FIG. 1.

FIG. 9 is a diagram for explaining a recommended item list generation processing in a recommended item presentation device shown in FIG. 1.

FIG. 10 is a flow chart for the processing at a time of a recommended item presentation response in a recommended item presentation device shown in FIG. 1.

FIG. 11 is a block diagram showing an exemplary configuration of a computer system for implementing a recommended item presentation device shown in FIG. 1.

FIG. 12 is a block diagram showing an exemplary configuration of a recommended item presentation system according to the second embodiment of the present invention.

FIG. 13 is a flow chart for the processing at a time of an access log transmission request in a recommended item presentation device shown in FIG. 12.

FIG. 14 is a flow chart for the processing at a time of collecting access logs in a recommended item presentation device shown in FIG. 12.

FIG. 15 is a flow chart for the processing at a time of a recommended item presentation in a recommended item presentation device shown in FIG. 12.

FIG. 16 is a diagram for explaining a recommended item list generation processing in a recommended item presentation device shown in FIG. 12.

FIG. 17 is a flow chart for the processing at a time of a recommended item delivery in a recommended item presentation device shown in FIG. 12.

FIG. 18 is a flow chart for the processing at a time of a log providing fee payment in a recommended item presentation device shown in FIG. 12.

FIG. 19 is a block diagram showing an exemplary configuration of a computer system for implementing a recommended item presentation device shown in FIG. 1.

FIG. 20 is a block diagram showing an exemplary configuration of a recommended item presentation device according to the third embodiment of the present invention.

FIG. 21 is a flow chart for the processing at a time of producing an access log map in a recommended item presentation device shown in FIG. 20.

FIG. 22 is a block diagram showing an exemplary configuration of a recommended item presentation device according to the fourth embodiment of the present invention.

FIG. 23 is a flow chart for the processing at a time of producing an access log map in a recommended item presentation device shown in FIG. 22.

### DETAILED DESCRIPTION OF THE INVENTION

First, the major features of the present invention will be briefly summarized.

In one aspect of the present invention, a list of recommended items is produced according to the access log for viewing/purchasing items on an item provider server made by a client who issued a recommended item presentation request and the rating of each item indicating the level of preference of each item by that client, and this list is sent to that client.

Namely, in this aspect of the present invention, a recommended item presentation device presents recommended items listed at an item provider server according to the access log of viewing/purchasing items on the item provider server by the client and the ratings of the items entered by the client which is the user preference estimating factor information, according to a contract with between the item provider and a company operating the recommended item presentation device.

Note that there can be cases where the item provider owns the recommended item presentation device.

By using the access log as the “analysis source information”, it becomes possible to collect a large amount of the “analysis source information”. Also, by using the ratings of the items entered by the client as the “user preference estimating factor information”, it becomes possible to explicitly indicate the user preference.

In another aspect of the present invention, a group of clients from which the access logs of viewing/purchasing items by accessing the item provider server who provides the items to a plurality of clients through a network is specified in advance, the access logs are received from the access log collecting target clients and stored, and a list of recommended items is produced according to the stored access logs and sent to a requesting source when there is a recommended item presenting request from a client.

By producing the list of recommended items according to the access logs collected from a group of clients who are specified in advance, rather than using the access logs collected from all the clients to whom the recommended item presenting service is provided, it becomes possible to suppress the requirements on the network load and the server processing power (compared with the case of dealing with the access logs of all the clients) even in the case of handling an enormous number of clients such as ten million clients or one hundred million clients, so that it becomes possible to provide the service with respect to an enormous number of clients such as ten million clients or one hundred million clients by utilizing the server device with similar processing power as that for handling one million clients.

In addition, this service becomes available even for a client who wishes to utilize the recommended item presenting service himself but who does not wish to have his own access log utilized for the purpose of the recommended item presentation to the other clients (even if the access log is to be statistically processed, for example).

Now, the definitions of some terms to be used in the following description will be described.

Items: Advertisements, information, titles and abstracts of CDs/books/movies, songs (music data), TV programs, etc.

Users: Users using the item providing server and the recommended item presentation device. Depending on the method for assigning the client identifiers, this term may indicate client terminals used by the users.

Item provider: A company that operates a server for providing items to a plurality of users. A company that operates an EC site for presenting/selling items such as CDs/Books, etc., a search/directory site for presenting/searching items such as Web contents, information, etc., or an electronic mall site for presenting/selling items such as goods by uniting a plurality of EC sites. A digital TV broadcast station/contents distribution company that broadcasts/distributes programs for the digital TV or the like, or a digital TV broadcast station/contents distribution company that provides information of goods or sells goods by using the bidirectional communication function of the digital TV or the like. Note that a server/device that is operated by such a company will be referred to as an item provider server.

Client: A terminal such as computer terminal, digital TV set, set-top box, IT home electronic device, etc., that makes accesses to the item provider server of the recommended item presentation device through a network.

Client identifier: An identifier by which the client can be uniquely identified at both the item provider server and the recommended item presentation device. It can be given by a membership number manually entered by the user, a timestamp recorded by using the Cookie function of the browser, etc.

Item identifier: An identifier by which an item can be uniquely identified at both the item provider server and the recommended item presentation device. In the case where each page of the Web pages is an item, a URL (Uniform Resource Locator) can be an item identifier, for example.

User preference estimating factor information: An information on a basis of which the user preference is to be estimated. In the present invention, it is given by a list of interested items entered by the user, a list of ratings on interested items entered by the user, etc. For example, the user specifies an item, and enters a rating of that item by selecting one of “very bad”, “bad”, “neutral”, “good”, and “very good”. At the system side, positive integers 1, 2, 3, 4 and 5 or integers −2, −1, 0, 1, 2 are assigned to these ratings.

The recommended item presentation: An operation of a server that carries out the service for providing items, in which the user preference is estimated by utilizing the user preference estimating factor information and a list of items that are expected to be of interest of the user is presented.

Access log of items: A log of viewing or purchasing items. It can be formed by a client identifier, an item identifier, and date and time of viewing/purchasing, for example.

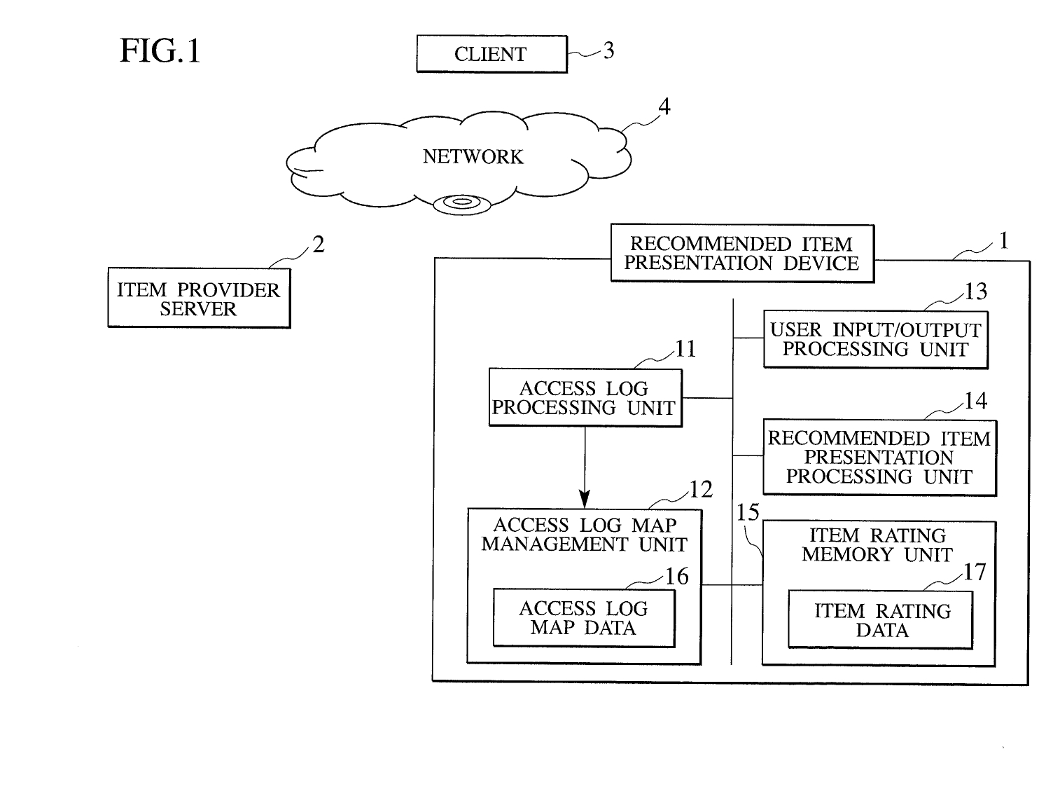

Referring now to FIG. 1 to FIG. 11, the first embodiment of a scheme for presenting recommended items to a client through a network according to the present invention will be described in detail.

FIG. 1 shows a configuration of a recommended item presentation system according to the first embodiment of the present invention.

This recommended item presentation system comprises a recommended item presentation device 1, an item provider server 2, a client 3, a network (Internet) 4.

The recommended item presentation device 1 comprises an access log processing unit 11, an access log map management unit 12, a user input/output processing unit 13, a recommended item presentation processing unit 14, and an item rating memory unit 15.

The access log processing unit 11 receives the access log transmitted from the item provider server 2, converts that access log into an access log map that is more suitable for the recommended item presentation processing, and transmits the access log map to the access log map management unit 12 along with an access log map storing request.

The access log map management unit 12 stores and manages the access log map received from the access log processing unit 11 as the access log map data 16.

The user input/output processing unit 13 transmits an item rating recording request transmitted from the client 3 to the item rating memory unit 15 along with “a client identifier, an item identifier, and a rating of that item”. The user input/output processing unit 13 also transmits a recommended item presentation request transmitted from the client 3 to the recommended item presentation processing unit 14 along with a client identifier. The user input/output processing unit 13 also transmits a recommended item presentation response received from the recommended item presentation processing unit 14 to the client of the client identifier from which the recommended item presentation request is received, along with a list of recommended items, and then carries out the charging of a fee to the item provider server 2.

The item rating memory unit 15 receives the client identifier, the item identifier and the rating value of that item that are transmitted along with the item rating recording request from the user input/output processing unit 13, and records the rating value related to the received client identifier and item identifier into the item rating data 17.

The recommended item presentation processing unit 14 receives the client identifier along with the recommended item presentation request from the user input/output processing unit 13, extracts a group of highly rated items related to that client identifier from the item rating memory unit 15, extracts a list of client identifiers (a group of related clients) stored in the access log map management unit 12 for each item identifier contained in the extracted group of highly rated items, narrows down the extracted group of related items, extracts a list of item identifiers (a group of related items) stored in the access log map management unit 12, narrows down items contained in the extracted group of related items, and transmits a recommended item presentation response containing the narrowed group of items as a recommended item list along with the client identifier of the recommended item presentation requesting source, to the user input/output processing unit 13.

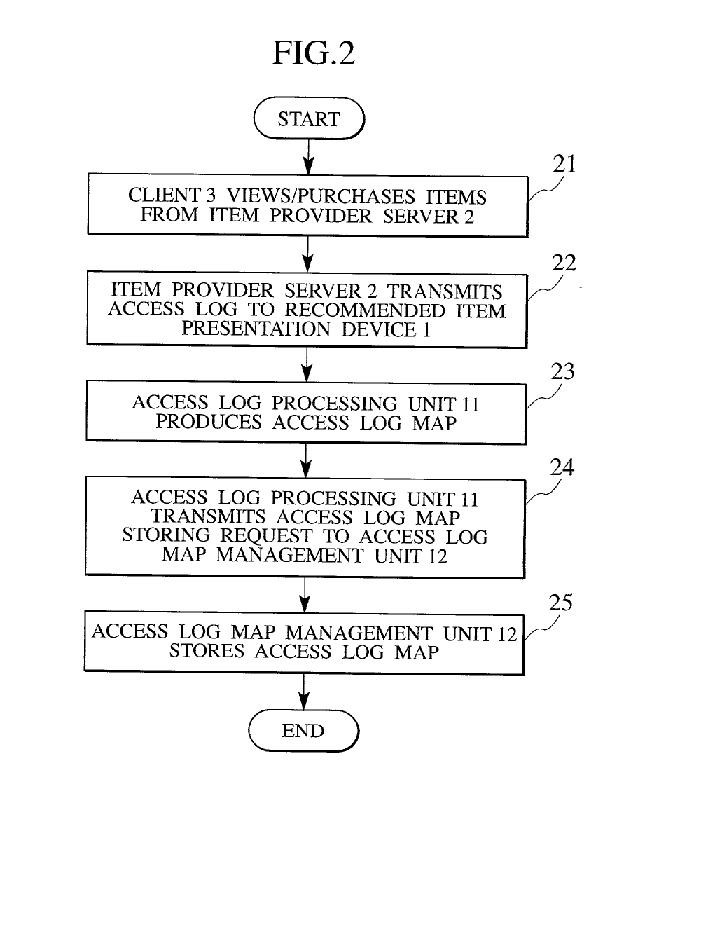

Next, the operations of the recommended item presentation system of this embodiment will be described. 1. Production of access log map (FIG. 2):

(1) The client 3 views/purchases items from the item provider server 2 (step 21);

When the client 3 accesses the item provider server 2 to view information and purchase goods provided there, these actions are stored as the access log in the item provider server 2.

(2) The item provider server 2 transmits the access log to the recommended item presentation device 1 (step 22);

The item provider server 2 transmits the stored access log regularly to the recommended item presentation device 1. Here, the access log is given in a form of a list of the client identifier, the item identifier and the access date and time, for example.

(3) The access log map is produced at the recommended item presentation device 1 (step 23);

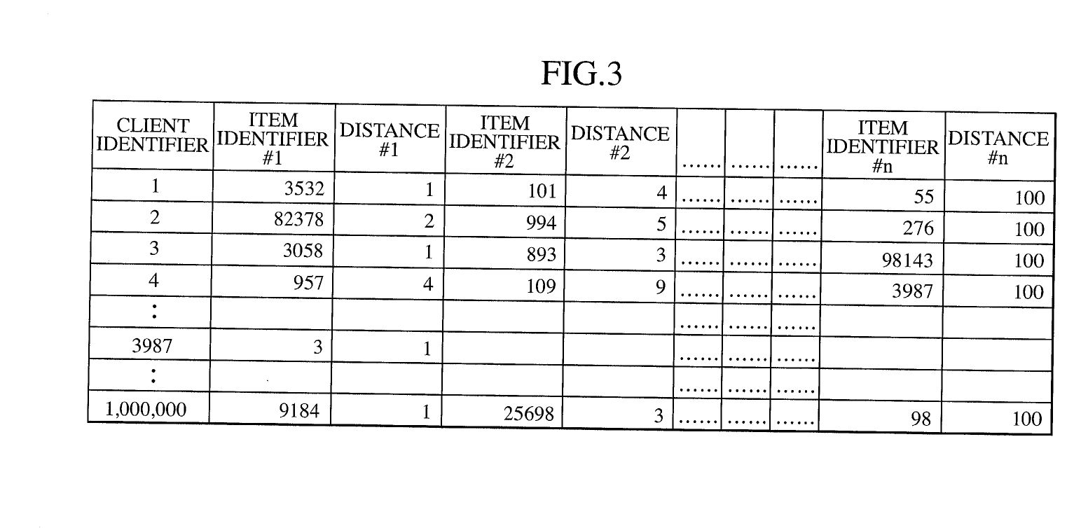

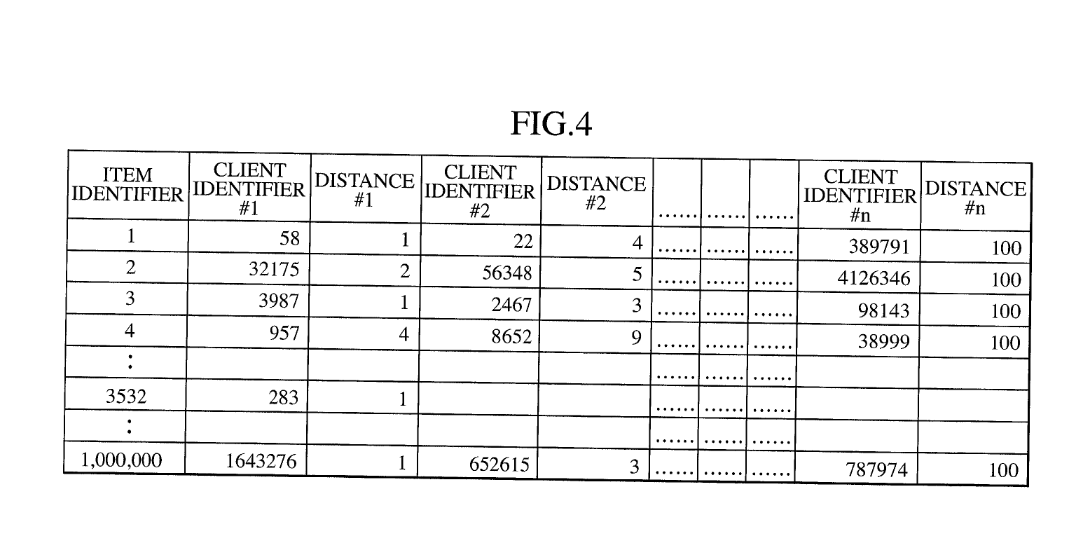

The access log processing unit 11 of the recommended item presentation device 1 receives the access log transmitted from the item provider server 2, and converts the access log into the access log map that is more suitable for the recommended item presentation processing. The access log map is given by a list of item identifiers and their distances for each client identifier as shown in FIG. 3, or a list of client identifiers and their distances for each item identifier as shown in FIG. 4, for example.

Here, the “distance” indicates a finite numerical value (between 1 and 100, for example) obtained by processing an information readable from the access log such as the number of accesses to that item or a time elapsed since the date and time of the latest access to that item, for example. In the case of the distance based on the number of accesses, the processing formula is set up such that the greater number of accesses corresponds to the closer distance, for example.

(4) The access log map storing request is transmitted from the access log processing unit 11 to the access log map management unit 12 (step 24);

The access log processing unit 11 transmits the access log map along with the access log map storing request to the access log map management unit 12, in order to record the access log map produced in the above (3).

(5) The access log map management unit 12 stores the access log map (step 25);

The access log map management unit 12 receives the access log map, and stores and manages the access log map in the access log map data 16.

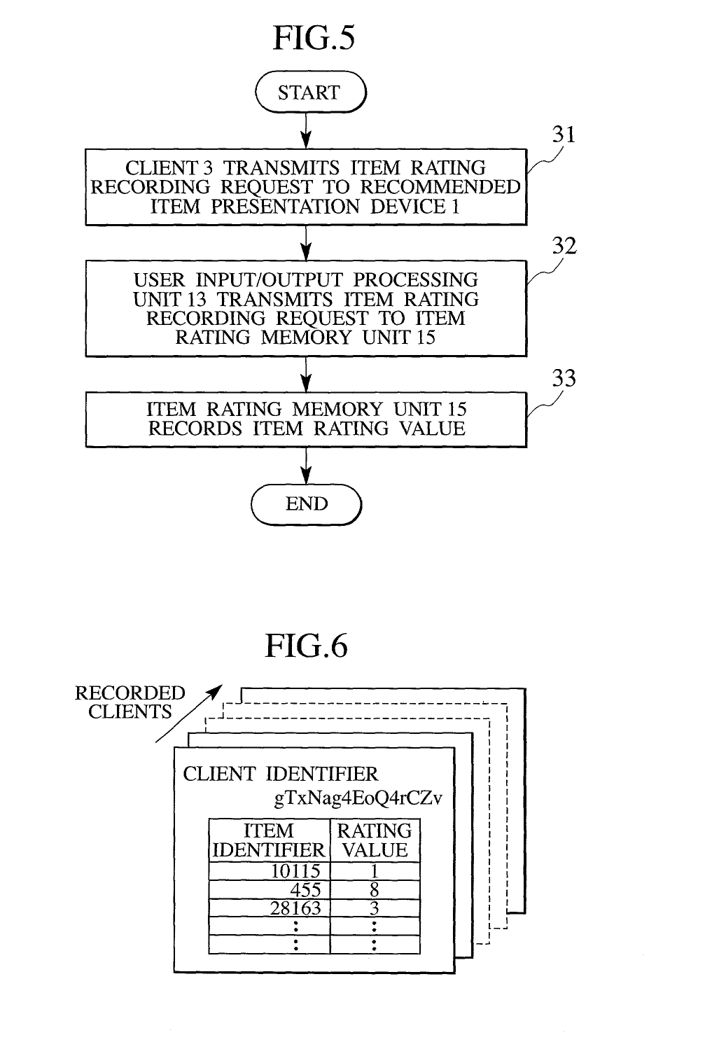

2. Recording of item rating (FIG. 5, FIG. 6):

(1) The client 3 transmits the item rating recording request to the recommended item presentation device 1 (step 31);

The client 3 transmits the rating value (the user preference estimating factor information) for a specific item, i.e., “the client identifier, the item identifier and the rating value of that item”, to the recommended item presentation device 1 along with the item rating recording request. Here, the rating value of the item is given by assigning positive integers 1, 2, 3, 4 and 5 to “very bad”, “bad”, “neutral”, “good”, and “very good”, one of which is to be selected by the user, for example.

(2) The user input/output processing unit 13 transmits the item rating recording request to the item rating memory unit 15 (step 32);

The user input/output processing unit 13 receives the item rating recording request, and transmits “the client identifier, the item identifier and the rating value of that item” to the item rating memory unit 15 along with the item rating recording request.

(3) The item rating memory unit 15 records the item rating value (step 33);

The item rating memory unit 15 receives the item rating recording request, and records the rating value related to the received client identifier and item identifier according to the received client identifier, into an entry for that client identifier in the item rating data (FIG. 6). In the case where the rating value for that item identifier is already recorded there, the rewriting of the rating value is carried out according to a pre-setting that indicates a policy of overwriting, a policy to give a priority to the latest rating, a policy to give a priority to a higher rating, a policy to give a priority to a lower rating, etc.

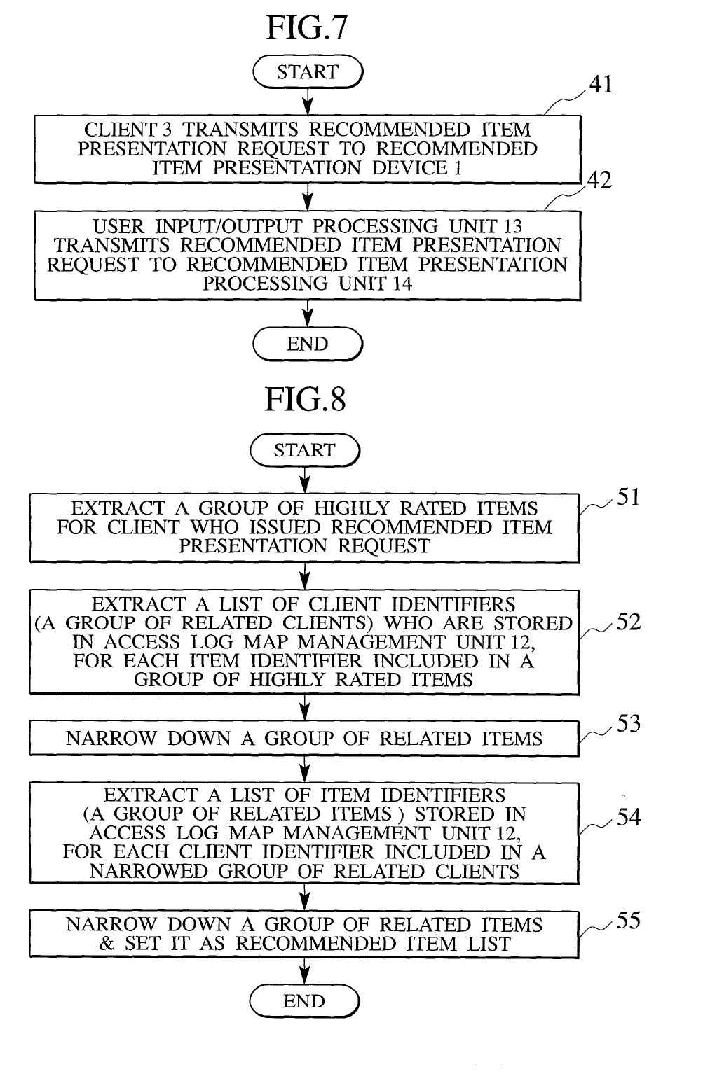

3. The recommended item presentation request (FIG. 7):

(1) The client 3 transmits the recommended item presentation request to the recommended item presentation device 1 (step 41);

The client 3 transmits the recommended item presentation request along with the client identifier to the user input/output processing unit 13 of the recommended item presentation device 1.

(2) The user input/output processing unit 13 transmits the recommended item presentation request to the recommended item presentation processing unit 14 (step 42);

The user input/output processing unit 13 receives the recommended item presentation request, and transmits the recommended item presentation request along with the client identifier to the recommended item presentation processing unit 14.

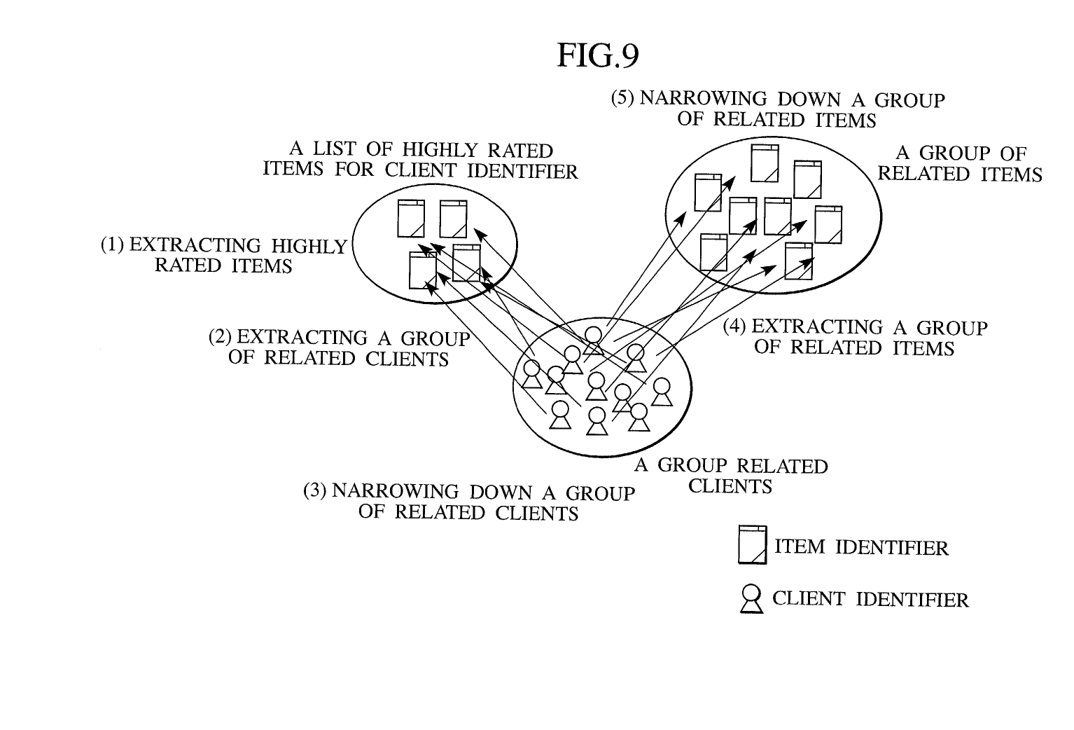

4. Generation of the recommended item list (FIG. 8, FIG. 9):

(1) The recommended item presentation processing unit 14 extracts a group of highly rated items for the requesting client (step 51);

The recommended item presentation processing unit 14 receives the recommended item presentation request, and according to the received client identifier, the recommended item presentation processing unit 14 also extracts a group of highly rated items related to that client identifier. The group of highly rated items is given by a list of top N1 item identifiers in the descending order of their rating values (where N1 is an integer greater than or equal to one), or a list of those item identifiers for which the rating value is greater than or equal to N2 (where N2 is an integer), that are extracted from a list of items and their rating values for each client identifier stored in the item rating data 17, for example.

(2) The recommended item presentation processing unit 14 extracts a group of related clients (step 52);

The recommended item presentation processing unit 14 extracts a list of client identifiers (a group of related clients) stored in the access log map management unit 12 for each item identifier contained in the group of highly rated items that are extracted by the above (1).

(3) The recommended item presentation processing unit 14 narrows down the group of related clients (step 53); The recommended item presentation processing unit 14 narrows down the group of related clients extracted by the above (2). An exemplary way of narrowing down is to re-arrange the group of related clients into the descending order of the number of accesses made with respect to the extracted group of highly rated items, and set top N3 related clients (where N3 is an integer greater than or equal to one) as a new group of related clients.

(4) The recommended item presentation processing unit 14 extracts the group of related items (step 54);

The recommended item presentation processing unit 14 extracts a list of item identifiers (a group of related items) that are stored in the access log map management unit 12 for each client identifier contained in the group of related clients narrowed by the above (3).

(5) The recommended item presentation processing unit 14 narrows down the group of related items (step 55);

The recommended item presentation processing unit narrows down the group of related items extracted by the above (4). An exemplary way of narrowing down is to rearrange the group of related items into the descending order of the number of accesses made from the group of related clients narrowed by the above (3), and set top N4 related items (where N4 is an integer greater than or equal to one) as a new group of related items (the recommended item list).

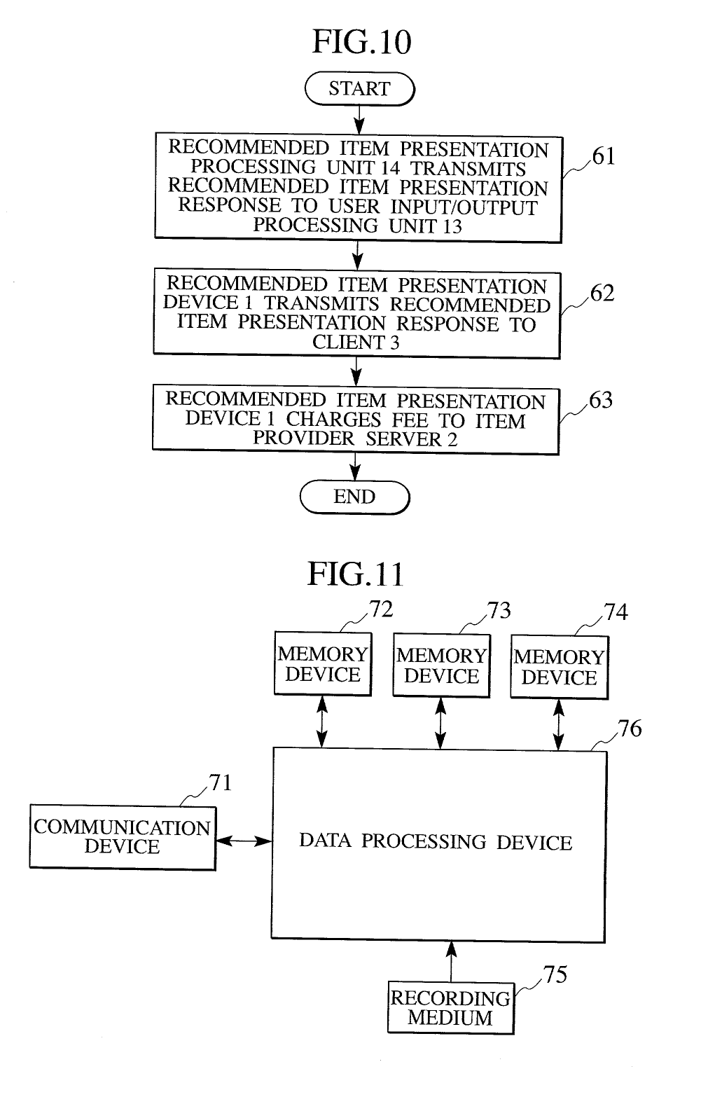

5. The recommended item presentation response (FIG. 10):

(1) The recommended item presentation processing unit 14 transmits the recommended item presentation response to the user input/output processing unit 13 (step 61);

The recommended item presentation processing unit 14 transmits the recommended item presentation response to the user input/output processing unit 13, along with the client identifier of the recommended item presentation requesting source and the recommended item list obtained by the above 4.(5).

(2) The recommended item presentation device 1 transmits the recommended item presentation response to the client 3 (step 62);

The user input/output processing unit 13 of the recommended item presentation device 1 transmits the recommended item presentation response along with the received recommended item list, to the client 3 that is the recommended item presentation requesting source according to the received client identifier.

(3) The recommended item presentation device 1 charges a fee to the item provider server 2 (step 63);

After the recommended item presentation response processing of the above (2) is finished, the user input/output processing unit 13 of the recommended item presentation device 1 charges a fee to the item provider server 2 according to the contract made in advance. The fee can be a monthly fixed rate fee, a meter rate fee according to the number of times for utilizing the recommended item presentation, or a meter fee rate according to the number of recommended items presented, for example.

FIG. 11 shows an exemplary configuration of a computer system for implementing the recommended item presentation device 1 of FIG. 1. A communication device 71 carries out communications with the client 3 and the item provider server 2. A memory device 72 stores the access log map data 16. A memory device 73 stores the item rating data 17. A memory device 74 is a hard disk device. A recording medium 75 is a floppy disk, CD-ROM, Magneto-optical disk or the like which records the recommended item presentation program for realizing the operations of the access log processing unit 11, the access log map management unit 12, the user input/output processing unit 13, the recommended item presentation processing unit 14 and the item rating memory unit 15 as shown in FIG. 2, FIG. 5, FIG. 7, FIG. 8 and FIG. 10. A data processing device 76 contains a CPU and interfaces for reading the recommended item presentation program from the recording medium 75 and executing this program.

As described, according to the first embodiment, the access log for viewing/purchasing items on the item provider server made by the client is used as the “analysis source information”, so that there is less burden of input on the client side and it becomes possible to collect a large amount of the “analysis source information”. Also, by using the rating input for each item or the list of preferred items as the “user preference estimating factor information” indicating the user preference, it becomes possible to explicitly indicate the user preference and to change it whenever necessary.

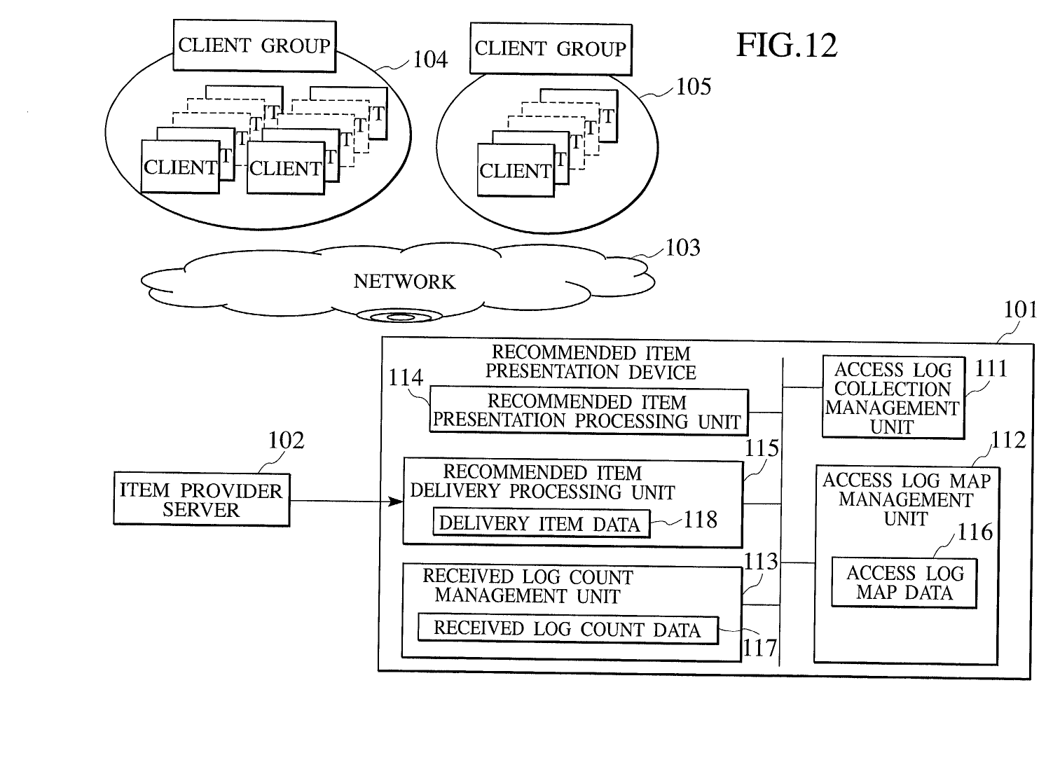

Referring now to FIG. 12 to FIG. 19, the second embodiment of a scheme for presenting recommended items to a client through a network according to the present invention will be described in detail.

FIG. 12 shows a configuration of a recommended item presentation system according to the second embodiment of the present invention.

This recommended item presentation system comprises a recommended item presentation device 101, an item provider server 102, a network 103, and client groups 104 and 105.

The recommended item presentation device 101 comprises an access log collection management unit 111, an access log map management unit 112, a received log count management unit 113, a recommended item presentation processing unit 114, and a recommended item delivery processing unit 115.

The access log collection management unit 111 receives an access log collecting client registration request from the item provider server 102 along with a list of client identifiers of those clients who are the access log collecting targets and a list of client identifiers of those clients which are not the access log collecting targets, and transmits an access log transmission request to those clients who are access log collecting targets and an access log transmission stopping request to those clients who are not the access log collecting targets.

Also, the access log collection management unit 111 receives the access log from the client converts it to an access log map which is more suitable for the recommended item presentation request processing, transmits the access log map to the access log map management unit 112 along with the access log map storing request, and transmits a log receiving recording request to the received log count management unit 113 along with a client identifier of the client from which the access log has been received.

The access log map management unit 12 stores and manages the access log map received from the access log collection management unit 111 as the access log map data 116.

The received log count management unit 113 increments the number of received access logs of the client identifier received from the access log collection management unit 111, and regularly counts the number of received access logs for each client identifier and transmits the number of received access logs to the item provider server 102.

The recommended item presentation processing unit 114 receives the client identifier of a client along with the recommended item presentation request and a list of item identifiers of items accessed by that client from the client, generates a recommended item list with respect to the client indicated by the received client identifier, and transmits the recommended item list along with the the access log map data managed by the access log map management unit 112.

The recommended item delivery processing unit 115 receives a list of item identifiers of items that should be delivered from the item provider server 102 along with an item delivery request, and records the list of item identifiers to the delivery item data 117.

Next, the operations of the recommended item presentation system of this embodiment will be described.

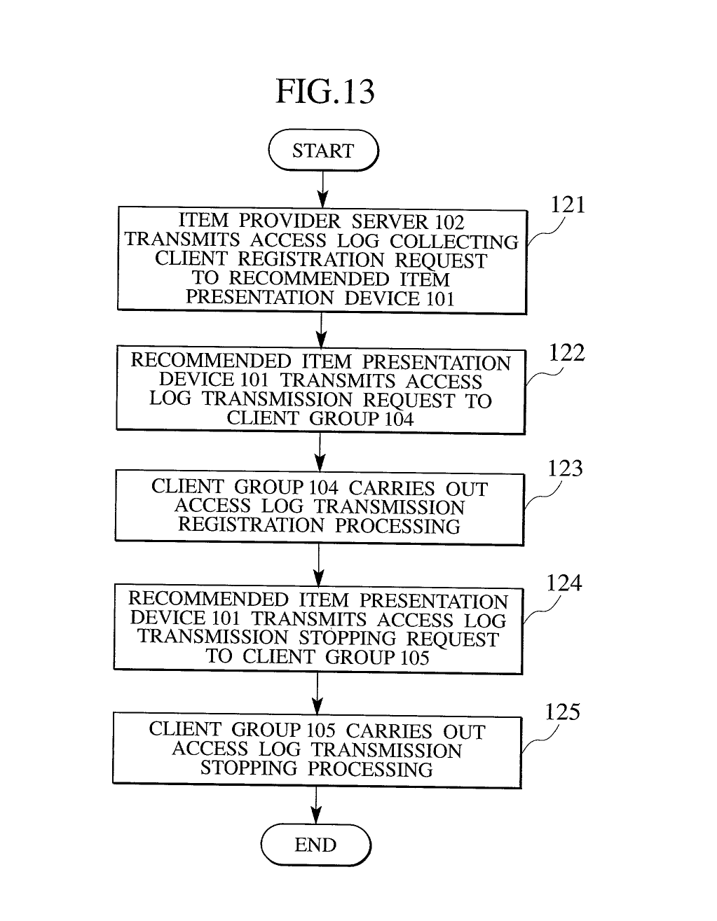

1. Access log transmission request (FIG. 13):

(1) The item provider server 102 transmits the access log collecting client registration request to the recommended item presentation device 101 (step 121);

The item provider server 102 specifies the client group from which the collection of the access logs is permitted according to the contracts (or agreements) with the clients made in advance, and transmits a list of client identifiers of those clients who are the access log collecting targets and a list of client identifiers of the clients who are not the access log collecting targets to the recommended item presentation device 101 along with the access log collecting client registration request.

(2) the recommended item presentation device 101 transmits an access log transmission request to the client group 104 (step 122);

The access log collection management unit 111 of the recommended item presentation device 101 transmits the access log transmission request for requesting the transmission of the access log to each client described in the list of the client identifiers of those clients who are the access log collecting targets as received at the above (1). Hereafter, the client group which transmitted the access log transmission request will be referred to as the client group 104.

(3) The access log transmission registration at the client group 104 (step 123);

Each client of the client group 104 that received the access log transmission request at the above (2) carries out the registration for transmitting the access log with respect to the item provider server 102, to the recommended item presentation device 101.

(4) The recommended item presentation device 101 transmits an access log transmission stopping request to the client group 105 (step 124);

After finishing the processing of the above (2), the recommended item presentation device 101 (the access log collection management unit 111) transmits the access log transmission stopping request for requesting the stopping of the transmission of the access log to each client described in the list of the client identifiers of those clients who are not the access log collecting targets as received at the above (1). Hereafter, the client group which received the access log transmission stopping request will be referred to as the client group 105.

There is no absolute need to send the access log transmission stopping request to all the clients who are not the access log collecting targets. For example, it is possible for each client to send the access log transmission stopping request only with respect to those for which the transmission stopping must be requested out of the list of client identifiers of the client group 104 stored in the recommended item presentation device 101 (the access log collection management unit 111) when there is a registration for not sending the access log in the initial state.

(5) The access log transmission stopping processing is carried out at the client group 105 (step 125);

Each client of the client group 105 that received the access log transmission stopping request at the 1.(4) above carries out a transmission stopping registration for not sending the access log with respect to the item provider server 102 to the recommended item presentation device 101 (the access log collection management unit 111).

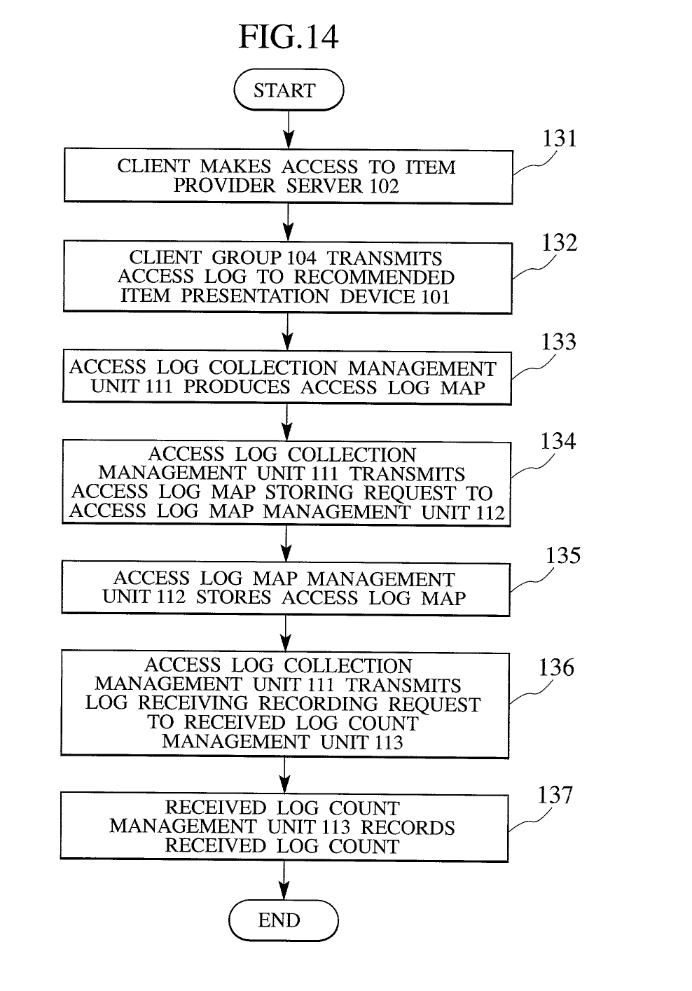

2. Collection of access logs (FIG. 14):

(1) the clients make accesses to the item providing server 102 (step 131);

Each client who belongs to the client group 104 and the client group 105 makes an access to each item of the item providing server 102. The access to each item is an act for viewing/purchasing information, goods, music, video, program, etc., that is provided by the item providing server 102.

(2) The client group 104 transmits the access log to the recommended item presentation device 101 (step 132);

Each client who belongs to the client group 104 and made an access to the item provider server 102 at the above 1.(1) transmits the access log to the recommended item presentation device 101. Here, the access log is given in a form of a list of the client identifier, the item identifier and the access date and time, for example.

(3) The access log map is produced at the recommended item presentation device 1 (step 133);

The access log collection management unit 111 of the recommended item presentation device 101 converts the access log received at the above (2) into the access log map that is more suitable for the recommended item presentation processing. The access log map is given by a list of item identifiers and their distances for each client identifier as shown in FIG. 3, or a list of client identifiers and their distances for each item identifier as shown in FIG. 4, for example.

Here, the “distance” indicates a finite numerical value (between 1 and 100, for example) obtained by processing an information readable from the access log such as the number of accesses to that item or a time elapsed since the date and time of the latest access to that item, for example. In the case of the distance based on the number of accesses, the processing formula is set up such that the greater number of accesses corresponds to the closer distance, for example.

(4) The access log map storing request is transmitted from the access log collection management unit 111 to the access log map management unit 112 (step 134);

The access log collection management unit 111 transmits the access log map along with the access log map storing request to the access log map management unit 112, in order to record the access log map produced in the above (3).

(5) The access log map management unit 112 stores the access log map (step 135);

The access log map management unit 112 stores and manages the access log map received at the above (4) in the access log map data 116.

(6) The access log collection management unit 111 transmits the log receiving recording request to the received log count management unit 113 (step 136);

The access log collection management unit 111 that transmitted the access log map storing request at the above

(4) transmits the log receiving recording request to the received log count management unit 113 along with the client identifier of the client from which the access log is received.

(7) The received log count management unit 113 records the received log count (step 137);

The received log count management unit 113 increments the number of received access logs of the received client identifier and stores it in the received log count data 117.

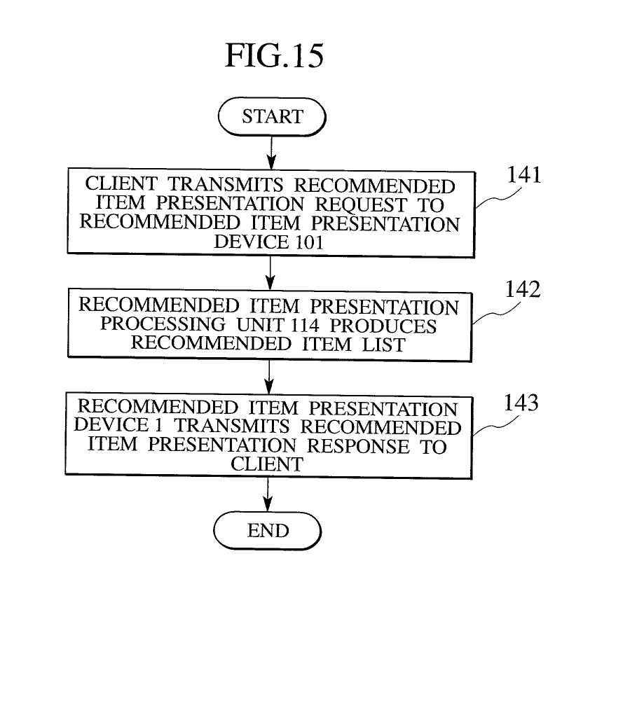

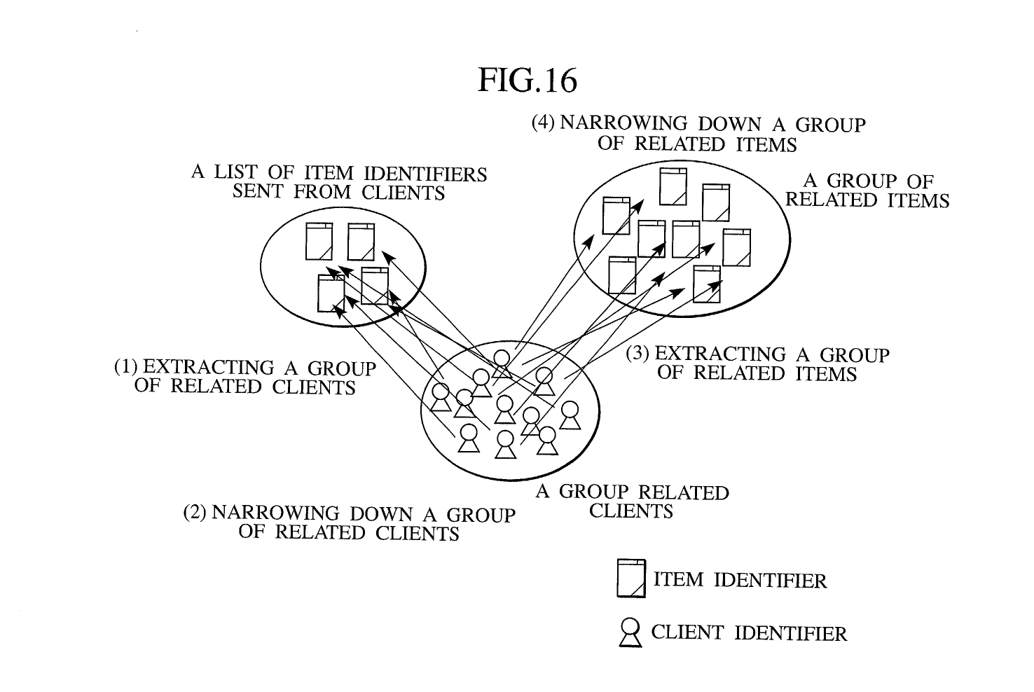

3. The recommended item presentation (FIG. 15 and FIG. 16):

(1) The client transmits the recommended item presentation request to the recommended item presentation device 101 (step 141);

The client (every client contained in the client group 104 and the client group 105) transmits the recommended item presentation request along with the client identifier and the list of item identifiers of the items accessed by the client. Here, in order to receive a more desirable presentation, the list of the item identifiers may be obtained by the intentional extraction operation such as that for extracting only those item identifiers of the items which are accessed recently from the list of the item identifiers or that for extracting only those item identifiers of items regarding the genre of the interest at that moment, for example.

(2) The recommended item presentation device 101 (the recommended item presentation processing unit 114) produces the recommended item list (step 142);

The recommended item presentation processing unit 114 of the recommended item presentation device 101 that received the recommended item presentation request produces the recommended item list for the client identified by the received client identifier according to the access log map data managed by the access log map management unit 112.

The method for producing the recommended item list is shown in FIG. 15.

<1>The processing for extracting a group of related clients from the access log map management unit 112 by the recommended item presentation processing unit 114;

The recommended item presentation processing unit 114 makes an access to the access log map data of the access log map management unit 112, and extracts a list of client identifiers (a group of related clients) of those clients who are accessing the item of each item identifier contained in the list of item identifiers received at the above (1).

<2>The processing for narrowing down the group of related clients by the recommended item presentation processing unit 114;

The recommended item presentation processing unit 114 carries out the processing for narrowing down the group of related clients extracted by the above <1>. An exemplary way of narrowing down is to re-arrange the group of related clients into the descending order of the number of accesses made with respect to the list of item identifiers received at the above (1), and set top N5 related clients (where N5 is an integer greater than or equal to one) as a new group of related clients.

<3>The processing for extracting the group of related items at the recommended item presentation processing unit 114;

The recommended item presentation processing unit 114 makes an access to the access log map data of the access log map management unit 112, and extracts a list of item identifiers (a group of related items) of items accessed by the client of each client identifier contained in the group of related clients narrowed by the above <2>.

<4>The processing for narrowing down the group of related items by the recommended item presentation processing unit 114;

The recommended item presentation processing unit 114 carries out the processing for narrowing down the group of related items extracted by the above <3>. An exemplary way of narrowing down is to re-arrange the group of related items into the descending order of the number of accesses made from the group of related clients narrowed by the above <2>, and set top N6 related items (where N6 is an integer greater than or equal to one) as a new group of related items. The group of related items narrowed by this processing will be referred to as the recommended item list.

(3) The recommended item presentation device 101 transmits the recommended item presentation response to the client (step 143);

The recommended item presentation processing unit 114 of the recommended item presentation device 101 transmits the recommended item presentation response along with the recommended item list narrowed by the above <4>, to the client that is the recommended item presentation requesting source according to the client identifier received by the above (1).

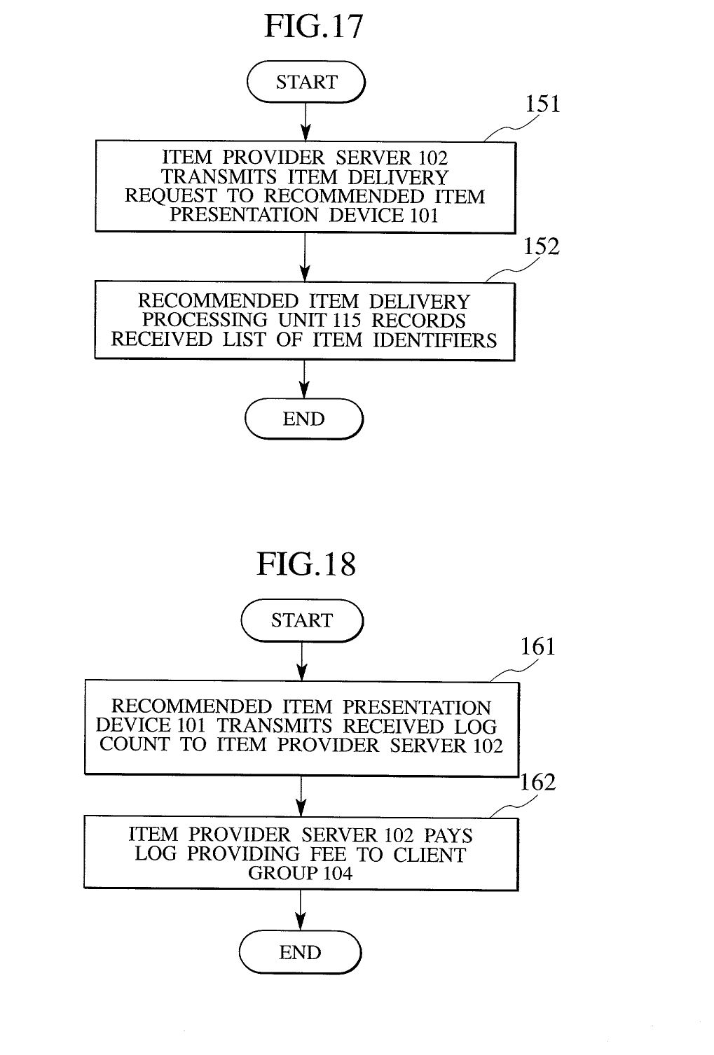

4. The delivery of the recommended items (FIG. 17):

The exemplary case of delivering the delivery items to those clients who are likely to have interests in the delivery items such as information on advertisements of goods for which the sales promotion is desired will be described.

(1) The item provider server 102 transmits the item delivery request to the recommended item presentation device 101 (step 151);

The item provider server 102 transmits the list of item identifiers of the items to be delivered along with the item delivery request, to the recommended item presentation device 101 (the recommended item delivery processing unit 115).

(2) The recommended item presentation device 101 records the item identifiers of the delivery items (step 152);

The recommended item delivery processing unit 115 of the recommended item presentation device 101 that received the item delivery request at the above (1) records the received list of item identifiers in the delivery item data 118.

When there is already the record of the delivery items, the processing of this 4.(2) is changed to the processing for narrowing down the group of related clients by the recommended item presentation processing unit 114.

The recommended item presentation processing unit 114 carries out the processing for narrowing down the group of related clients extracted at the above <1>. An exemplary way of narrowing down is to re-arrange the group of related clients into the descending order of the number of accesses made with respect to the list of item identifiers received at the above 3.(1), further re-arrange them such that those item identifiers recorded as the delivery items in the delivery item data of the recommended item delivery processing unit 115 are placed at higher positions, and set top N7 related clients (where N7 is an integer greater than or equal to one) as a new group of related clients.

By this processing, it is possible to increase the possibility of purchases for the specific goods.

5. The payment of the log providing fee (FIG. 18):

It is expected that there are many cases in which some fees are to be paid for the providing of the access logs from the client group 104. The received log count management unit 113 contributes to the payment of the log providing fee.

(1) The recommended item presentation device 101 (the received log count management unit 113) transmits the received log count to the item provider server 102 (step 161);

The received log count management unit 113 counts the number of received access logs for each client identifier of the client group 104 which transmitted the access log to the recommended item presentation device 101 regularly within a monitoring period, and transmits that received log count to the item provider server 102.

(2) The item provider server 102 pays the log providing fee to the client group 104 (step 162);

The item provider server 102 pays the log providing fee to the clients who provided the access logs according to the received log count for each client identifier received at the above 5.(1).

The log providing fee can be a fixed rate fee or a meter rate fee according to the number of provided logs which is to be paid to each client according to the contract between the item provider server 102 and each client belonging to the client group 104.

The payment of the log providing fee may be realized in a form of a discount of the utilization fee of the item provider server 102, a discount or an exemption of the rental/lease fee of the communication device or the client terminal, or an issuance of a coupon or a discount at a time of purchasing goods.

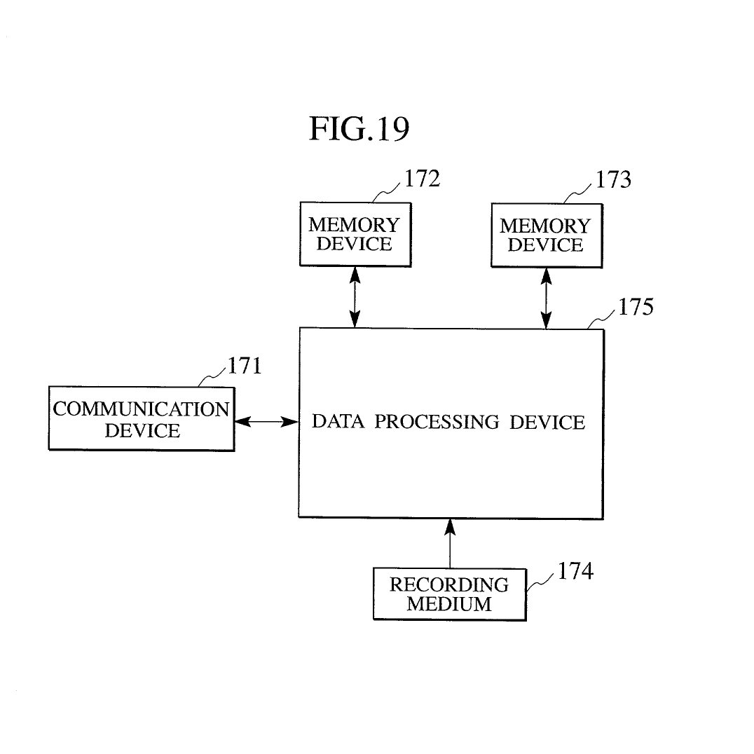

FIG. 19 shows an exemplary configuration of a computer system for implementing the recommended item presentation device 101 of FIG. 12. A communication device 171 carries out communications with the client groups 104 and 105 and the item provider server 102. A memory device 172 stores the access log map data 116, the received log count data 117, and the delivery item data 118. A memory device 173 is a hard disk device. A recording medium 174 is a floppy disk, CD-ROM, Magneto-optical disk or the like which records the recommended item presentation program for realizing the operations of the access log collection management unit 111, the access log map management unit 112, the received log count management unit 113, the recommended item presentation processing unit 114 and the recommended item delivery processing unit 115 as shown in FIG. 13, FIG. 14, FIG. 15, FIG. 17 and FIG. 18. A data processing device 175 contains a CPU and interfaces for reading the recommended item presentation program from the recording medium 174 and executing this program.

As described, according to the second embodiment, the recommended item presentation service is provided to all the clients according to the access logs collected from some client group that is contracted in advance, so that it is possible to provide the service with respect to an enormous number of clients while suppressing the requirements on the network load and the server processing power.

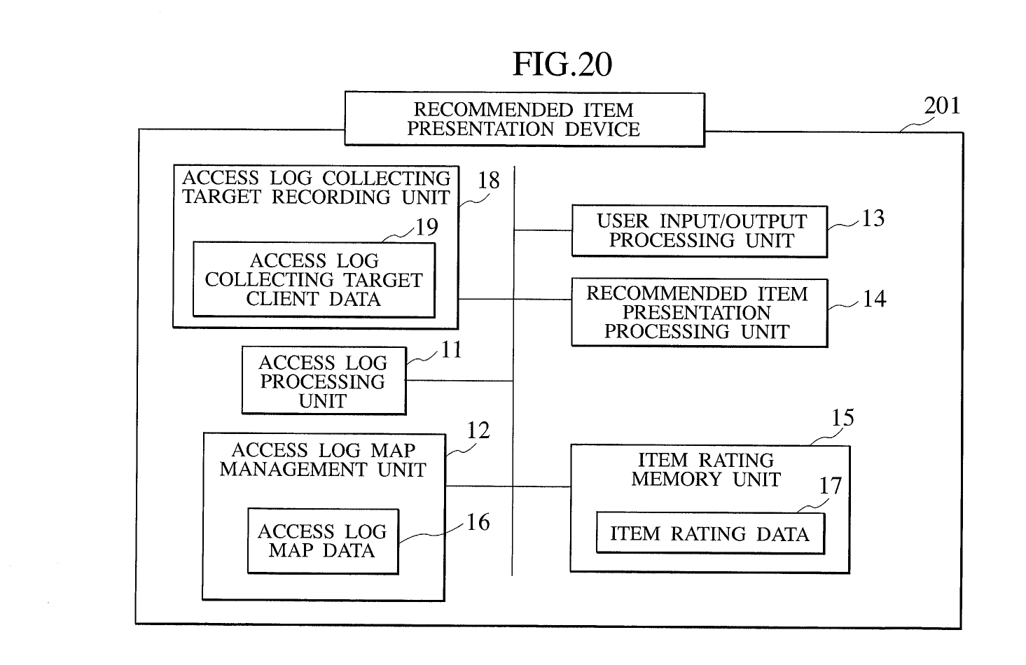

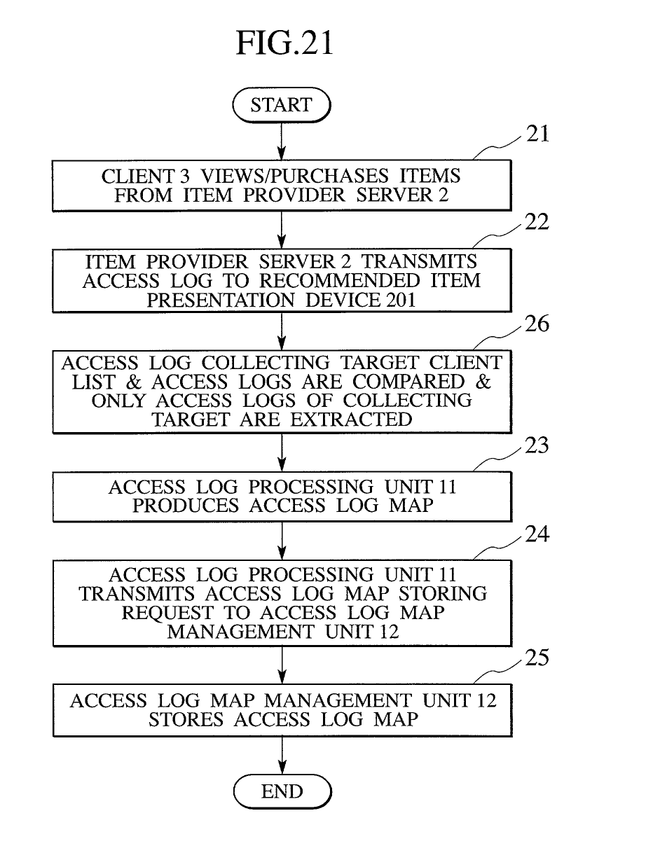

Referring now to FIG. 20 and FIG. 21, the third embodiment of a scheme for presenting recommended items to a client through a network according to the present invention will be described in detail. The third embodiment is directed to a case of combining the first and second embodiments described above.

FIG. 20 shows a configuration of a recommended item presentation device 201 according to the third embodiment of the present invention, which differs from the recommended item presentation device 1 shown in FIG. 1 in that an access log collecting target recording unit 18 for storing access log collecting target client data 19 is additionally provided. The other elements are the same as those appearing in FIG. 1 and the same reference numerals are given in the drawings.

Next, the operations of the recommended item presentation device 201 of this embodiment will be described.

In this case, before the access log transmission request is made, the access log collecting target recording unit 18 receives a list of clients who are the access log collecting targets and a list of clients who are not the access log collecting targets from the item provider server 2, and stores them as the access log collecting target client data 19.

FIG. 21 shows the operation for producing the access log map, which corresponds to FIG. 2 for the first embodiment described above. In this operation of FIG. 21, after the access logs for the client's viewing/purchasing of items are transmitted from the item provider server 2 to the recommended item presentation device 201 at the step 22, the access logs are compared with the access log collecting target client list from the access log collecting target recording unit 18, and only the access logs of the collecting targets are extracted at the step 26. The rest of the operation of FIG. 21 is the same as in FIG. 2.

In this case, the recording of the item rating is carried out similarly as in the first embodiment.

The recommended item presentation request is made as follows.

(1) The recommended item presentation device 201 receives the recommended item presentation request from the client 3;

The recommended item presentation request is received from the client 3 along with the client identifier and/or the list of item identifiers of items accessed by the client 3. Here, in order to receive a more desirable presentation, the list of the item identifiers may be obtained by the intentional extraction operation such as that for extracting only those item identifiers of the items which are accessed recently from the list of the item identifiers or that for extracting only those item identifiers of items regarding the genre of the interest at that moment, for example.

(2) The user input/output processing unit 13 transmits the recommended item presentation request to the recommended item presentation processing unit 14.

The user input/output processing unit 13 transmits the received client identifier and/or the list of item identifiers to the recommended item presentation processing unit 14.

The generation of the recommended item list is carried out similarly as in the first embodiment by producing a group of highly rated items, and the received item identifiers will be added to the group of highly rated items in this case.

The other operations of the recommended item presentation device 201 are the same as those of the first embodiment described above.

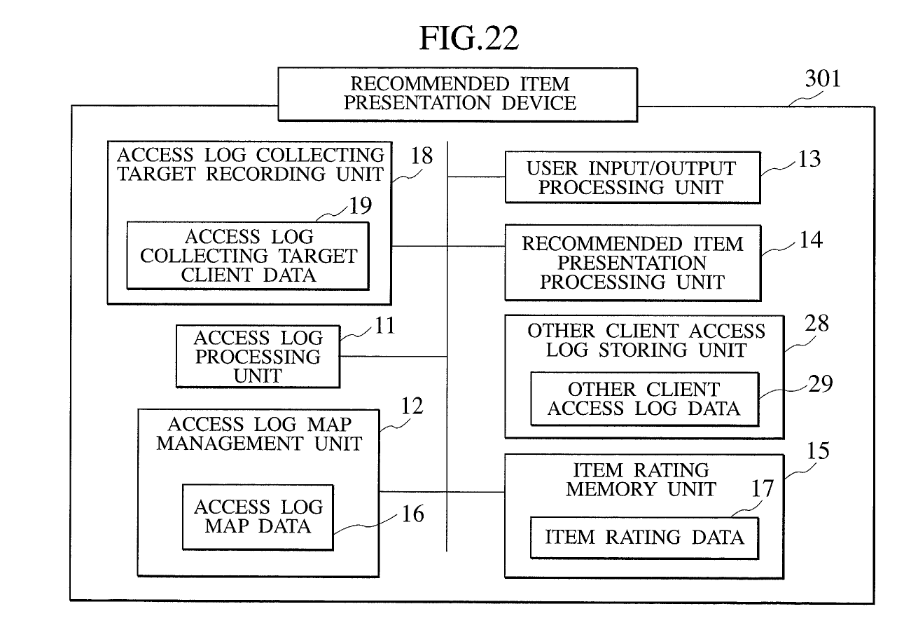

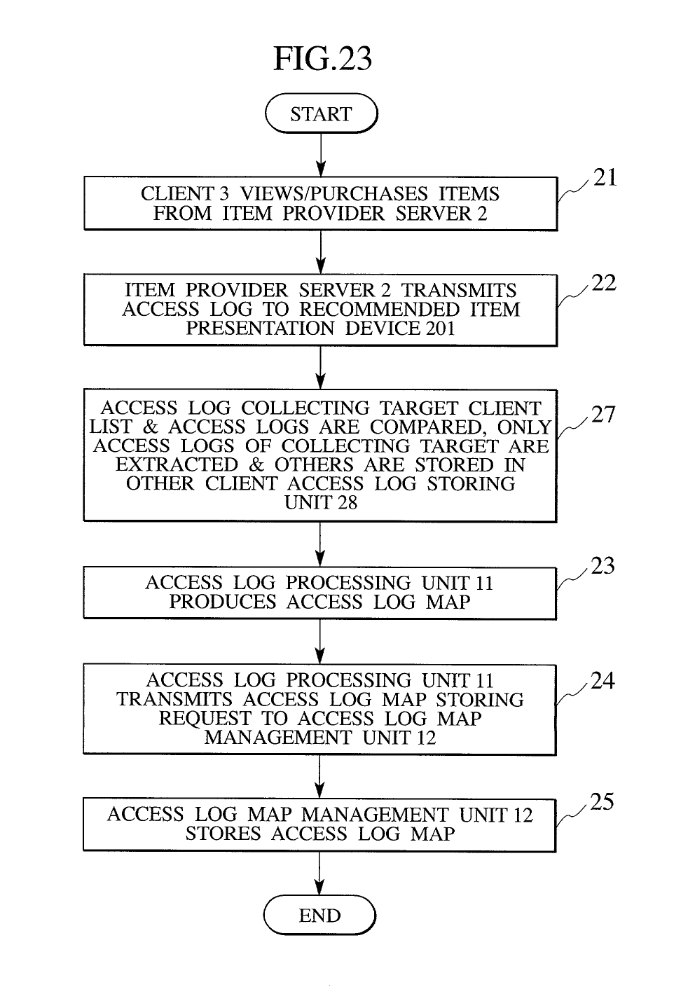

Referring now to FIG. 22 and FIG. 23, the fourth embodiment of a scheme for presenting recommended items to a client through a network according to the present invention will be described in detail. The fourth embodiment is also directed to a case of combining the first and second embodiments described above.

FIG. 22 shows a configuration of a recommended item presentation device 301 according to the fourth embodiment of the present invention, which differs from the recommended item presentation device 201 shown in FIG. 20 in that an other client access log storing unit 28 for storing other client access log data 29 is additionally provided. The other elements are the same as those appearing in FIG. 20 and the same reference numerals are given in the drawings.

Next, the operations of the recommended item presentation device 301 of this embodiment will be described.

In this case, before the access log transmission request is made, the access log collecting target recording unit 18 receives a list of clients who are the access log collecting targets and a list of clients who are not the access log collecting targets from the item provider server 2, and stores them as the access log collecting target client data 19.

FIG. 23 shows the operation for producing the access log map, which corresponds to FIG. 2 for the first embodiment described above. In this operation of FIG. 23, after the access logs for the client's viewing/purchasing of items are transmitted from the item provider server 2 to the recommended item presentation device 301 at the step 22, the access logs are compared with the access log collecting target client list from the access log collecting target recording unit 18, and only the access logs of the collecting targets are extracted, converted into the access log maps and stored, while the other access logs of the other clients that are not extracted are stored into the other client access log storing unit 28 as the other client access log data at the step 27. The rest of the operation of FIG. 23 is the same as in FIG. 2.

In this case, the recording of the item rating and the recommended item presentation request are carried out similarly as in the first embodiment.

The generation of the recommended item list is basically carried out similarly as in the first embodiment, and in addition, if the access log of the received client identifier is stored in the other client access log storing unit 28, that item identifier will be added to the group of highly rated items.

The other operations of the recommended item presentation device 201 are the same as those of the first embodiment described above.

It is to be noted that the following variations are possible for the above described embodiments.

The network is not necessarily limited to the Internet. It can be a digital bidirectional TV, an IT home electronics network, etc.

The client can be a PC (Personal Computer), a portable telephone, a digital bidirectional TV set, an IT home electronics device, a word-processor capable of communications, a game device capable of communications, a clock capable of communications, a terminal capable of mobile communications such as PDA (Personal Digital Assistants), etc.

The input/output is not necessarily limited to Web pages. it is possible to utilize e-mails for the transmission of the access log, or for the transmission of the item rating recording request, the recommended item presentation request, the client identifier, etc., as documents or titles of the e-mails. It is also possible to utilize the e-mail address instead of the client identifier. It is also possible to transmit the recommended item list as an e-mail document.

The client identifier can be managed in correspondence with a customer identifier different from the client identifier. The customer identifier can be a unique identifier entered arbitrarily at the client side, an ID assigned by the recommended item presentation device separately from the client identifier, etc.

The recommended item presentation can be realized in a form of a display superposed on a TV screen or a game display.

It is also to be noted that the above described embodiments according to the present invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art.

In particular, the recommended item presentation device of each of the above described embodiments can be conveniently implemented in a form of a software package.

Such a software package can be a computer program product which employs a storage medium including stored computer code which is used to program a computer to perform the disclosed function and process of the present invention. The storage medium may include, but is not limited to, any type of conventional floppy disks, optical disks, CD-ROMs, magneto-optical disks, ROMs, RAMs, EPROMs, EEPROMs, magnetic or optical cards, or any other suitable media for storing electronic instructions.

It is also to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A recommended item presentation method, comprising the steps of:
(a) receiving access logs for viewing/purchasing items by clients from an item provider server which provides items to a plurality of clients through a network, converting the access logs into access log maps suitable for a recommended item presentation processing, and storing the access log maps;
(b) receiving and storing item rating values indicating levels of preference of clients regarding specific items from the clients;
(c) receiving a recommended item presentation request from a client;
(d) producing a recommended item list for the client who issued the recommended item presentation request, according to the item rating values and the access log maps for the client who issued the recommended item presentation request; and
(e) transmitting the recommended item list to the client who issued the recommended item presentation request.

2. The method of claim 1, wherein the step (a) obtains each access log map as a list of item identifiers and their distances for each client identifier or a list of client identifiers and their distances for each item identifier, where a distance for each item is given by processing an information readable from each access log that contains a number of accesses made to each item or date and time of a latest access to each item.

3. The method of claim 2, wherein the step (d) includes the steps of:
(d1) extracting a group of highly rated items of the client given by a list of item identifiers of a prescribed number of items from a top in the list of item identifiers and their rating values for each client identifier or a list of item identifiers of those items for which the item rating values are greater than a prescribed value;
(d2) extracting a group of related clients given by a list of client identifiers stored in the access log map for each item identifier contained in the group of highly rated items extracted by the step (d1);
(d3) narrowing down the group of related clients extracted by the step (d2);
(d4) extracting a group of related items given by a list of item identifiers stored in the access log map for each client identifier contained in the group of related clients narrowed by the step (d3); and
(d5) obtaining the recommended item list by narrowing down the group of related items extracted by the step (d4).

4. The method of claim 3, wherein the step (d3) narrows down the group of related clients by rearranging the group of related clients in a descending order of a number of accesses with respect to the group of highly rated items extracted by the step (d1) and setting a prescribed number of clients from a top of a rearranged group of related clients as a new group of related clients, and the step (d5) narrows down the group of related items by rearranging the group of related items in a descending order of a number of accesses from the new group of related clients obtained by the step (d3) and setting a prescribed number of items from a top of a rearranged group of related items as the recommended item list.

5. A recommended item presentation method, comprising the steps of:
(a) receiving and storing access log collecting target client data indicating those clients who are targets for collecting access logs for viewing/purchasing items by clients from an item provider server which provides items to a plurality of clients through a network, and those clients who are not targets for collecting the access logs from the item provider server;
(b) receiving the access logs for clients from the item provider server, extracting only the access logs of those clients who are targets for collecting the access logs from the access logs received from the item provider server according to the access log collecting target client data stored by the step (a), converting only extracted access logs into access log maps suitable for a recommended item presentation processing, and storing the access log maps;
(c) receiving a recommended item presentation request from a client;
(d) producing a recommended item list for the client who issued the recommended item presentation request, according to the access log maps for the client who issued the recommended item presentation request; and
(e) transmitting the recommended item list to the client who issued the recommended item presentation request.

6. The method of claim 5, wherein the step (c) receives a client identifier of the client and a list of item identifiers of items accessed by the client, along with the recommended item presentation request, and the step (d) produces the recommended item list also according to the list of item identifiers received by the step (c).

7. The method of claim 5, further comprising the steps of:
(f) storing the access logs for those clients who are not targets for collecting the access logs, separately from the access log maps for those clients who are targets for collecting the access logs, according to the access log collecting target client data stored by the step (a);
wherein the step (d) produces the recommended item list for the client according to the the access log maps obtained from the client when the client is one of those clients who are targets for collecting the access logs, or according to the access logs for the client stored by the step (f) when the client is one of those clients who are not targets for collecting the access logs.

8. The method of claim 5, further comprising the step of:
(g) receiving and storing item rating values indicating levels of preference of the clients regarding specific items from the clients;
wherein the step (d) produces the recommended item list for the client also according to the item rating values for the client stored by the step (g).

9. The method of claim 5, wherein the step (b) obtains each access log map as a list of item identifiers and their distances for each client identifier or a list of client identifiers and their distances for each item identifier, where a distance for each item is given by processing an information readable from each access log that contains a number of accesses made to each item or date and time of a latest access to each item.

10. The method of claim 9, wherein the step (d) includes the steps of:
(d1) extracting a group of highly rated items of the client given by a list of item identifiers of a prescribed number of items from a top in the list of item identifiers and their rating values for each client identifier or a list of item identifiers of those items for which the item rating values are greater than a prescribed value;
(d2) extracting a group of related clients given by a list of client identifiers stored in the access log map for each item identifier contained in the group of highly rated items extracted by the step (d1);
(d3) narrowing down the group of related clients extracted by the step (d2);
(d4) extracting a group of related items given by a list of item identifiers stored in the access log map for each client identifier contained in the group of related clients narrowed by the step (d3); and
(d5) obtaining the recommended item list by narrowing down the group of related items extracted by the step (d4).

11. The method of claim 10, wherein the step (d3) narrows down the group of related clients by rearranging the group of related clients in a descending order of a number of accesses with respect to the group of highly rated items extracted by the step (d1) and setting a prescribed number of clients from a top of a rearranged group of related clients as a new group of related clients, and the step (d5) narrows down the group of related items by rearranging the group of related items in a descending order of a number of accesses from the new group of related clients obtained by the step (d3) and setting a prescribed number of items from a top of a rearranged group of related items as the recommended item list.

12. A recommended item presentation method, comprising the steps of:
(a) receiving access log collecting target client data indicating those clients who are targets for collecting access logs for viewing/purchasing items by clients from an item provider server which provides items to a plurality of clients through a network, and those clients who are not targets for collecting the access logs from the item provider server, sending access log transmission requests to those clients who are targets for collecting the access logs, and sending access log transmission stopping requests to those clients who are not targets for collecting the access logs;
(b) receiving the access logs from those clients who are targets for collecting the access logs, converting the access logs into access log maps suitable for a recommended item presentation processing, and storing the access log maps;
(c) receiving a recommended item presentation request from a client;
(d) producing a recommended item list for the client who issued the recommended item presentation request, according to the access log maps for the client who issued the recommended item presentation request; and
(e) transmitting the recommended item list to the client who issued the recommended item presentation request.

13. The method of claim 12, further comprising the step of:
(f) receiving and recording a list of item identifiers of items to be delivered from the item provider server, along with an item delivery request.

14. The method of claim 12, further comprising the steps of:
(g) incrementing a received log count of each client when an access log is received from each client; and
(h) regularly counting the received log count of each client and transmitting a counted received log count of each client to the item provider server.

15. The method of claim 14, further comprising the step of:
(i) paying a log providing fee from the item provider server to each client who provided the access logs according to the received log count of each client transmitted at the step (h).

16. The method of claim 12, wherein the step (b) obtains each access log map as a list of item identifiers and their distances for each client identifier or a list of client identifiers and their distances for each item identifier, where a distance for each item is given by processing an information readable from each access log that contains a number of accesses made to each item or date and time of a latest access to each item.

17. The method of claim 12, wherein the step (c) receives a client identifier of the client and a list of item identifiers of items accessed by the client, along with the recommended item presentation request, and the step (d) produces the recommended item list also according to the list of item identifiers received by the step (c).

18. The method of claim 17, wherein the step (d) includes the steps of:
(d1) extracting a group of related clients given by a list of client identifiers of those clients who are accessing each item whose item identifier is contained in the list of item identifiers received by the step (c), according to the access log maps stored by the step (b);
(d2) narrowing down the group of related clients extracted by the step (d1);
(d3) extracting a group of related items given by a list of item identifiers of items accessed by each client whose client identifier is contained in the group of related clients narrowed by the step (d2), according to the access log maps stored by the step (b); and
(d4) obtaining the recommended item list by narrowing down the group of related items extracted by the step (d3).

19. The method of claim 18, wherein the step (d2) narrows down the group of related clients by rearranging a group of related clients in a descending order of a number of accesses with respect to items whose item identifiers are contained in the list of item identifiers received by the step (c) and setting a prescribed number of clients from a top of a rearranged group of related clients as a new group of related clients, and the step (d4) narrows down the group of related items by rearranging the group of related items in a descending order of a number of accesses from the new group of related clients obtained by the step (d2) and setting a prescribed number of items from a top of a rearranged group of related items as the recommended item list.

20. The method of claim 18, wherein the step (d2) narrows down the group of related clients by rearranging a group of related clients in a descending order of a number of accesses with respect to items whose item identifiers are contained in the list of item identifiers received by the step (c) and setting a prescribed number of clients from a top of a rearranged group of related clients as a new group of related clients, and the step (d4) narrows down the group of related items by rearranging a group of items contained in the recommended item list in a descending order of a number of accesses from the new group of related clients obtained by the step (d2) and setting a prescribed number of items from a top of a rearranged group of items as a new recommended item list.

21. A recommended item presentation device, comprising:
a first unit configured to receive access logs for viewing/purchasing items by clients from an item provider server which provides items to a plurality of clients through a network, convert the access logs into access log maps suitable for a recommended item presentation processing, and store the access log maps;
a second unit configured to receive and store item rating values indicating levels of preference of clients regarding specific items from the clients;
a third unit configured to receive a recommended item presentation request from a client;
a fourth unit configured to produce a recommended item list for the client who issued the recommended item presentation request, according to the item rating values and the access log maps for the client who issued the recommended item presentation request; and
a fifth unit configured to transmit the recommended item list to the client who issued the recommended item presentation request.

22. The device of claim 21, wherein the first unit obtains each access log map as a list of item identifiers and their distances for each client identifier or a list of client identifiers and their distances for each item identifier, where a distance for each item is given by processing an information readable from each access log that contains a number of accesses made to each item or date and time of a latest access to each item.

23. The device of claim 22, wherein the fourth unit extracts a group of highly rated items of the client given by a list of item identifiers of a prescribed number of items from a top in the list of item identifiers and their rating values for each client identifier or a list of item identifiers of those items for which the item rating values are greater than a prescribed value; extracts a group of related clients given by a list of client identifiers stored in the access log map for each item identifier contained in the group of highly rated items as extracted; narrows down the group of related clients as extracted; extracts a group of related items given by a list of item identifiers stored in the access log map for each client identifier contained in the group of related clients as narrowed; and obtains the recommended item list by narrowing down the group of related items as extracted.

24. The device of claim 23, wherein fourth unit narrows down the group of related clients by rearranging the group of related clients in a descending order of a number of accesses with respect to the group of highly rated items as extracted and setting a prescribed number of clients from a top of a rearranged group of related clients as a new group of related clients, and narrows down the group of related items by rearranging the group of related items in a descending order of a number of accesses from the new group of related clients as obtained and setting a prescribed number of items from a top of a rearranged group of related items as the recommended item list.

25. A recommended item presentation device, comprising:
a first unit configured to receive and store access log collecting target client data indicating those clients who are targets for collecting access logs for viewing/purchasing items by clients from an item provider server which provides items to a plurality of clients through a network, and those clients who are not targets for collecting the access logs from the item provider server;
a second unit configured to receive the access logs for clients from the item provider server, extracting only the access logs of those clients who are targets for collecting the access logs from the access logs received from the item provider server according to the access log collecting target client data stored by the first unit, convert only extracted access logs into access log maps suitable for a recommended item presentation processing, and store the access log maps;
a third unit configured to receive a recommended item presentation request from a client;
a fourth unit configured to produce a recommended item list for the client who issued the recommended item presentation request, according to the access log maps for the client who issued the recommended item presentation request; and
a fifth unit configured to transmit the recommended item list to the client who issued the recommended item presentation request.

26. The device of claim 25, wherein the third unit receives a client identifier of the client and a list of item identifiers of items accessed by the client, along with the recommended item presentation request, and the fourth unit produces the recommended item list also according to the list of item identifiers received by the third unit.

27. The device of claim 25, further comprising:
a sixth unit configured to store the access logs for those clients who are not targets for collecting the access logs, separately from the access log maps for those clients who are targets for collecting the access logs, according to the access log collecting target client data stored by the first unit;
wherein the fourth unit produces the recommended item list for the client according to the the access log maps obtained from the client when the client is one of those clients who are targets for collecting the access logs, or according to the access logs for the client stored by the sixth unit when the client is one of those clients who are not targets for collecting the access logs.

28. The device of claim 25, further comprising:
a sixth unit configured to receive and store item rating values indicating levels of preference of the clients regarding specific items from the clients;
wherein the fourth unit produces the recommended item list for the client also according to the item rating values for the client stored by the sixth unit.

29. The device of claim 25, wherein the second unit obtains each access log map as a list of item identifiers and their distances for each client identifier or a list of client identifiers and their distances for each item identifier, where a distance for each item is given by processing an information readable from each access log that contains a number of accesses made to each item or date and time of a latest access to each item.

30. The device of claim 29, wherein the fourth unit extracts a group of highly rated items of the client given by a list of item identifiers of a prescribed number of items from a top in the list of item identifiers and their rating values for each client identifier or a list of item identifiers of those items for which the item rating values are greater than a prescribed value; extracts a group of related clients given by a list of client identifiers stored in the access log map for each item identifier contained in the group of highly rated items as extracted; narrows down the group of related clients as extracted; extracts a group of related items given by a list of item identifiers stored in the access log map for each client identifier contained in the group of related clients as narrowed; and obtains the recommended item list by narrowing down the group of related items as extracted.

31. The device of claim 30, wherein the fourth unit narrows down the group of related clients by rearranging the group of related clients in a descending order of a number of accesses with respect to the group of highly rated items as extracted and setting a prescribed number of clients from a top of a rearranged group of related clients as a new group of related clients, and narrows down the group of related items by rearranging the group of related items in a descending order of a number of accesses from the new group of related clients as obtained and setting a prescribed number of items from a top of a rearranged group of related items as the recommended item list.

32. A recommended item presentation device, comprising:
a first unit configured to receive access log collecting target client data indicating those clients who are targets for collecting access logs for viewing/purchasing items by clients from an item provider server which provides items to a plurality of clients through a network, and those clients who are not targets for collecting the access logs from the item provider server, send access log transmission requests to those clients who are targets for collecting the access logs, and send access log transmission stopping requests to those clients who are not targets for collecting the access logs;
a second unit configured to receive the access logs from those clients who are targets for collecting the access logs, convert the access logs into access log maps suitable for a recommended item presentation processing, and store the access log maps;
a third unit configured to receive a recommended item presentation request from a client;
a fourth unit configured to produce a recommended item list for the client who issued the recommended item presentation request, according to the access log maps for the client who issued the recommended item presentation request; and
a fifth unit configured to transmit the recommended item list to the client who issued the recommended item presentation request.

33. The device of claim 32, further comprising:
a sixth unit configured to receive and record a list of item identifiers of items to be delivered from the item provider server, along with an item delivery request.

34. The device of claim 32, further comprising:
a sixth unit configured to increment a received log count of each client when an access log is received from each client; and
a seventh unit configured to regularly count the received log count of each client and transmit a counted received log count of each client to the item provider server.

35. The device of claim 32, wherein the second unit obtains each access log map as a list of item identifiers and their distances for each client identifier or a list of client identifiers and their distances for each item identifier, where a distance for each item is given by processing an information readable from each access log that contains a number of accesses made to each item or date and time of a latest access to each item.

36. The device of claim 32, wherein the third unit receives a client identifier of the client and a list of item identifiers of items accessed by the client, along with the recommended item presentation request, and the fourth unit produces the recommended item list also according to the list of item identifiers received by the third unit.

37. The device of claim 36, wherein the fourth unit extracts a group of related clients given by a list of client identifiers of those clients who are accessing each item whose item identifier is contained in the list of item identifiers received by the third unit, according to the access log maps stored by the second unit; narrows down the group of related clients as extracted; extracts a group of related items given by a list of item identifiers of items accessed by each client whose client identifier is contained in the group of related clients as narrowed, according to the access log maps stored by the second unit; and obtains the recommended item list by narrowing down the group of related items as extracted.

38. The device of claim 37, wherein the fourth unit narrows down the group of related clients by rearranging a group of related clients in a descending order of a number of accesses with respect to items whose item identifiers are contained in the list of item identifiers received by the third unit and setting a prescribed number of clients from a top of a rearranged group of related clients as a new group of related clients, and narrows down the group of related items by rearranging the group of related items in a descending order of a number of accesses from the new group of related clients as obtained and setting a prescribed number of items from a top of a rearranged group of related items as the recommended item list.

39. The device of claim 37, wherein the fourth unit narrows down the group of related clients by rearranging a group of related clients in a descending order of a number of accesses with respect to items whose item identifiers are contained in the list of item identifiers received by the third unit and setting a prescribed number of clients from a top of a rearranged group of related clients as a new group of related clients, and narrows down the group of related items by rearranging a group of items contained in the recommended item list in a descending order of a number of accesses from the new group of related clients as obtained and setting a prescribed number of items from a top of a rearranged group of items as a new recommended item list.

40. A computer usable medium having computer readable program codes embodied therein for causing a computer to function as a recommended item presentation device, the computer readable program codes include:
a first computer readable program code for causing said computer to receive access logs for viewing/purchasing items by clients from an item provider server which provides items to a plurality of clients through a network, convert the access logs into access log maps suitable for a recommended item presentation processing, and store the access log maps;
a second computer readable program code for causing said computer to receive and store item rating values indicating levels of preference of clients regarding specific items from the clients;
a third computer readable program code for causing said computer to receive a recommended item presentation request from a client;
a fourth computer readable program code for causing said computer to produce a recommended item list for the client who issued the recommended item presentation request, according to the item rating values and the access log maps for the client who issued the recommended item presentation request; and
a fifth computer readable program code for causing said computer to transmit the recommended item list to the client who issued the recommended item presentation request.

41. A computer usable medium having computer readable program codes embodied therein for causing a computer to function as a recommended item presentation device, the computer readable program codes include:
a first computer readable program code for causing said computer to receive and store access log collecting target client data indicating those clients who are targets for collecting access logs for viewing/purchasing items by clients from an item provider server which provides items to a plurality of clients through a network, and those clients who are not targets for collecting the access logs from the item provider server;
a second computer readable program code for causing said computer to receive the access logs for clients from the item provider server, extracting only the access logs of those clients who are targets for collecting the access logs from the access logs received from the item provider server according to the access log collecting target client data stored by the first computer readable program code, convert only extracted access logs into access log maps suitable for a recommended item presentation processing, and store the access log maps;
a third computer readable program code for causing said computer to receive a recommended item presentation request from a client;
a fourth computer readable program code for causing said computer to produce a recommended item list for the client who issued the recommended item presentation request, according to the access log maps for the client who issued the recommended item presentation request; and
a fifth computer readable program code for causing said computer to transmit the recommended item list to the client who issued the recommended item presentation request.

42. A computer usable medium having computer readable program codes embodied therein for causing a computer to function as a recommended item presentation device, the computer readable program codes include:
a first computer readable program code for causing said computer to receive access log collecting target client data indicating those clients who are targets for collecting access logs for viewing/purchasing items by clients from an item provider server which provides items to a plurality of clients through a network, and those clients who are not targets for collecting the access logs from the item provider server, send access log transmission requests to those clients who are targets for collecting the access logs, and send access log transmission stopping requests to those clients who are not targets for collecting the access logs;
a second computer readable program code for causing said computer to receive the access logs from those clients who are targets for collecting the access logs, convert the access logs into access log maps suitable for a recommended item presentation processing, and store the access log maps;
a third computer readable program code for causing said computer to receive a recommended item presentation request from a client;
a fourth computer readable program code for causing said computer to produce a recommended item list for the client who issued the recommended item presentation request, according to the access log maps for the client who issued the recommended item presentation request; and
a fifth computer readable program code for causing said computer to transmit the recommended item list to the client who issued the recommended item presentation request.
